(19) United States
(12) Patent Application Publication
(10) Pub. No.: US 2016/0353442 A1
(43) Pub. Date: Dec. 1, 2016

(54) USER APPARATUS, BASE STATION, AND CARRIER AGGREGATION CONTROL METHOD

(71) Applicant: NTT DOCOMO, INC., Tokyo (JP)

(72) Inventors: Tooru Uchino, Tokyo (JP); Kohei Kiyoshima, Tokyo (JP); Hideaki Takahashi, Tokyo (JP); Yuta Sagae, Tokyo (JP)

(73) Assignee: NTT DOCOMO, INC., Tokyo (JP)

(21) Appl. No.: 15/117,486

(22) PCT Filed: Feb. 9, 2015
(86) PCT No.: PCT/JP2015/053504

§ 371 Date: Aug. 9, 2016

(30) Foreign Application Priority Data
Feb. 12, 2014 (JP) 2014-024832

(51) Int. Cl. H04W 72/04; H04W 76/04; H04B 7/06; H04L 12/26

(52) U.S. Cl. CPC H04W 72/0453; H04L 43/16; H04W 72/0446; H04W 76/045; H04B 7/0626

(57) ABSTRACT

A user apparatus in a mobile communication system supporting carrier aggregation includes a measurement unit configured to measure a reception timing difference between component carriers; an information notification unit configured to notify the base station of information on the reception timing difference measured by the measurement unit; and a control unit configured to perform addition or deletion of a secondary cell in the carrier aggregation based on an instruction from the base station that receives the information.

### TECHNICAL FIELD

The present invention relates to a user apparatus UE and a base station eNB in a mobile communication system that performs carrier aggregation.

### BACKGROUND ART

In LTE-Advanced, in order to realize throughput exceeding that of LTE while keeping backward compatibility with LTE, carrier aggregation (CA) is adopted for performing communication by simultaneously using a plurality of carriers using a bandwidth (20 MHz at the maximum) supported by LTE as a basic unit. In carrier aggregation, a carrier which is a basic unit is called a component carrier (CC).

The carrier aggregation is classified into three scenarios as shown in FIGS. 1 (a)-1 (c) according to frequency arrangement of CCs. FIG. 1 (a) shows Intra-band contiguous CA, which is a scenario in which continuous CCs are arranged in a band. For example, this scenario is applied when assignment of a wideband such as 3.5 GHz is performed. FIG. 1 (b) shows Inter-band non-contiguous CA, which is a scenario in which a plurality of CCs of different bands are arranged. This scenario is applied, for example, when communication is performed by using a plurality of carriers such as 2 GHz band and 1.5 GHz band and the like. FIG. 1 (c) shows Intra-band non-contiguous CA, which is a scenario in which non-contiguous CCs are arranged within the same band. For example, this scenario is applied when fragmentary assignment of frequency bands is performed to the operator.

When CA is performed, the user apparatus UE is configured with a PCell (Primary cell) that is highly reliable for keeping connectivity, and an SCell (Secondary cell) that is a subsidiary cell. The user apparatus UE connects to the PCell first, and then, can add an SCell as necessary. The PCell is a cell similar to a cell of the LTE scheme supporting RLM (Radio Link Monitoring), and SPS (Semi-Persistent Scheduling) and the like.

Also, the SCell is a cell that is set in the user apparatus UE in addition to the PCell. Addition and deletion of the SCell are performed by an RRC (Radio Resource Control) signaling. Since the SCell is in a deactivated state right after it is set in the user apparatus UE, communication becomes available (scheduling becomes available) only after being activated in a MAC (Media Access Control) layer. A CC corresponding to a PCell is called a PCC (Primary Component Carrier), and a CC corresponding to an SCell is called an SCC (Secondary Component Carrier).

### RELATED ART DOCUMENT

### Non-Patent Document

[Non-PATENT DOCUMENT 1] 3GPP TS 36.300 V11.3.0 (2012-09)

### SUMMARY OF THE INVENTION

When applying the CA, measurement management becomes necessary in terms of handover associated with mobility, and CC addition and deletion. Thus, it is possible that the user apparatus UE measures a reception level (RSRP Reference Signal Received Power) of connecting (serving) and neighboring cells, or a reception quality (RSRQ: Reference Signal Received Quality) of connecting (serving) and neighboring cells for each CC so as to report it to the base station eNB as a measurement report when a specific condition (event) is satisfied.

On the other hand, when setting CA, it is necessary that a reception timing difference (delay spread) between CCs in the user apparatus UE falls within a predetermined threshold (Annex J of non-patent document 1). That is, for example, in a form of CA that forms a macrocell and a small cell as shown in FIG. 2, a reception timing difference in receiving signals, by the user apparatus UE, that are transmitted from the macro eNB and the small eNB at the same time need to fall within a predetermined threshold. This is because, if the reception timing difference becomes larger than the predetermined threshold, the user apparatus UE cannot properly process the timing difference so that there is a possibility that reception quality is deteriorated.

Depending on operation, there is a possibility that the reception timing difference between CCs does not fall within a predetermined threshold. However, the base station eNB cannot know such an event.

For example, when this event occurs, it is considered that the user apparatus UE reports a very small value as a CQI. However, the base station eNB cannot determine whether quality of the SCell is deteriorated or whether out-of-reception window occurs (reception timing difference becomes equal to or greater than a predetermined threshold).

For example, even when a reception timing of an SCell is displaced with respect to a criterial timing (example: reception timing of PCell) by equal to or more than a threshold so that the reception timing becomes out of a reception window, there is a possibility that a measurement report is not transmitted (for example, by Event A2) when quality of the SCell itself is good. The base station eNB performs control of exchanging CCs, replacing a CC which is being used with an unused CC having good quality based on a measurement report of each CC. However, when the base station eNB cannot know the event, an SCell that cannot be used is always kept. Thus, it is not desirable in terms of battery saving of the user apparatus UE, NW resource, and radio resource.

The present invention is contrived from the viewpoint of the above-mentioned points, and tone or more embodiments provide a technique that enables a base station to ascertain a reception timing difference between CCs in a user apparatus so as to properly perform addition or deletion of an SCell in a mobile communication system that performs CA.

### Means for Solving the Problem

According to one or more embodiments of the present invention, there is provided a user apparatus in a mobile communication system supporting carrier aggregation, including:

a measurement unit configured to measure a reception timing difference between component carriers;

an information notification unit configured to notify the base station of information on the reception timing difference measured by the measurement unit; and a control unit configured to perform addition or deletion of a secondary cell in the carrier aggregation based on an instruction from the base station that receives the information.

Also, according to one or more embodiments of the present invention, there is provided a base station in a mobile communication system supporting carrier aggregation, including:

a reception unit configured to receive, from a user apparatus, information on a reception timing difference between component carriers for a component carrier;

a determination unit configured to determine whether to add or delete a secondary cell corresponding to the component carrier based on information on the reception timing difference received by the reception unit; and

an information notification unit configured to instruct the user apparatus to add or delete the secondary cell based on a determination result by the determination unit.

Also, according to one or more embodiments of the present invention, there is provided a carrier aggregation control method executed by a user apparatus in a mobile communication system supporting carrier aggregation, including:

a measurement step of measuring a reception timing difference between component carriers;

an information notification step of notifying the base station of information on the reception timing difference measured by the measurement step; and

a control step of performing addition or deletion of a secondary cell in the carrier aggregation based on an instruction from the base station that receives the information.

Also, according to one or more embodiments of the present invention, there is provided a carrier aggregation control method executed by a base station in a mobile communication system supporting carrier aggregation, including:

a reception step of receiving, from a user apparatus, information on a reception timing difference between component carriers for a component carrier;

a determination step of determining whether to add or delete a secondary cell corresponding to the component carrier based on information on the reception timing difference received by the reception step; and

an information notification step of instructing the user apparatus to add or delete the secondary cell based on a determination result by the determination step.

### Effect of the Present Invention

According to one or more embodiments of the present invention, there is provided a technique that enables a base station to ascertain a reception timing difference between CCs in a user apparatus so as to properly perform addition or deletion of an SCell in a mobile communication system that performs CA.

### BRIEF DESCRIPTION OF THE DRAWINGS

FIGS. 1 (a)-1 (c) are diagrams showing frequency arrangement examples of carrier aggregation;

FIG. 2 is a diagram for explaining an example of a reception timing difference between CCs in CA;

FIG. 3 is a block diagram of a mobile communication system in one or more embodiments of the present invention;

FIG. 4 is a process sequence in a first example;

FIG. 5 is a diagram for explaining an inter-CC reception timing difference;

FIG. 6 is a process sequence in a second example;

FIGS. 7 (a) and 7 (b) are diagrams for explaining a method for determining within/out of reception window;

FIG. 8 is a diagram showing an example of a MAC CE for reporting information on a reception timing difference;

FIG. 9 is a process sequence of another example in the second example;

FIG. 10 is a functional block diagram of the user apparatus UE;

FIG. 11 is a flowchart indicating basic operation of the user apparatus UE;

FIG. 12 is a functional block diagram of the base station eNB;

FIG. 13 is a flowchart indicating basic operation of the base station eNB.

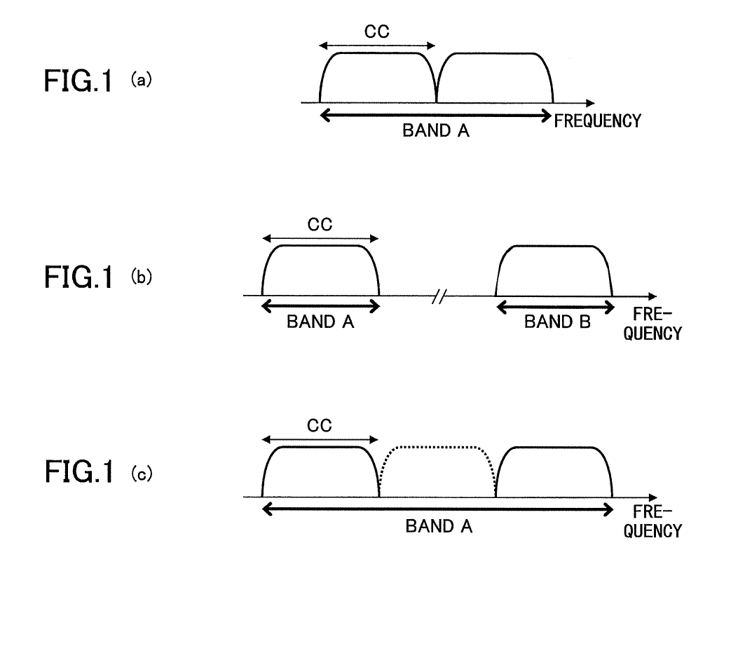

### EMBODIMENTS FOR CARRYING OUT THE INVENTION

In the following, embodiments of the present invention are described with reference to figures. The embodiments described below are merely examples, and the embodiments to which the present invention is applied are not limited to the embodiments below. For example, although it is assumed that a communication system of one or more embodiments comply with LTE including LTE-Advanced, the present invention is not limited to LTE, and can be applied to other schemes that perform CA. In the following, unless otherwise stated, “LTE” is used as having a meaning including LTE-Advanced.

### System Configuration

### Operation Example

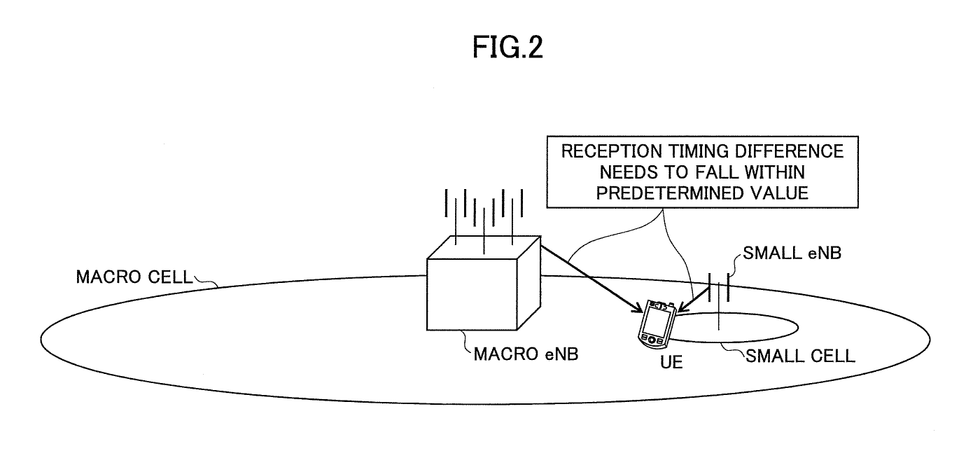

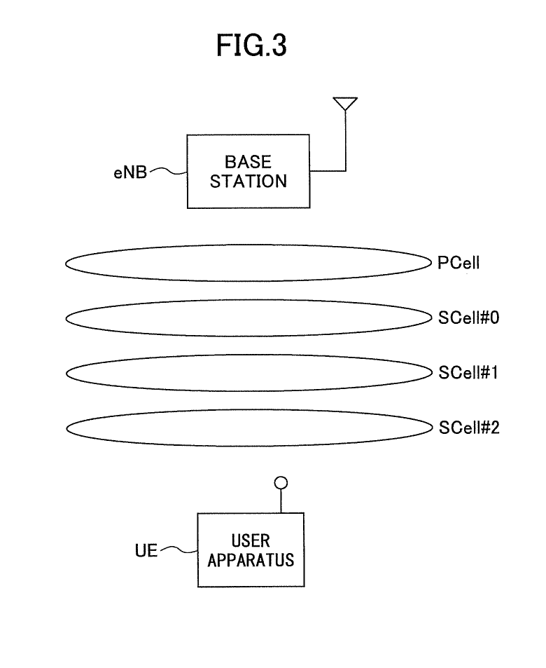

FIG. 3 shows a block diagram of a mobile communication system in one or more embodiments of the present invention. The mobile communication system in one or more embodiments shown in FIG. 3 is a mobile communication system of the LTE scheme, and includes a base station eNB that manages a PCell and SCells #0-#2, and a user apparatus UE. Although 3 SCells are set in the example shown in FIG. 3, this is merely an example. Also, although each of the PCell and the SCells #0-#2 may include an uplink cell and a downlink cell, one or more embodiments especially focus on a downlink direction. Also, although FIG. 3 shows one user apparatus UE and one base station eNB, this is merely an example, and a plurality of ones for each apparatus may exist. Also, the system may be a form of CA in which the user apparatus UE performs communication with a plurality of base stations eNB at the same time as shown in FIG. 2.

As described before, in a conventional technique, the base station eNB cannot ascertain the reception timing difference between CCs. On the other hand, one or more embodiments remove this effect, and enable the base station eNB to ascertain the reception timing difference between CCs.

In the following, a case where an SCell is added is described as a first example, and a case where an SCell is deleted is described as a second example.

### First Example

### A Case for Adding an SCell

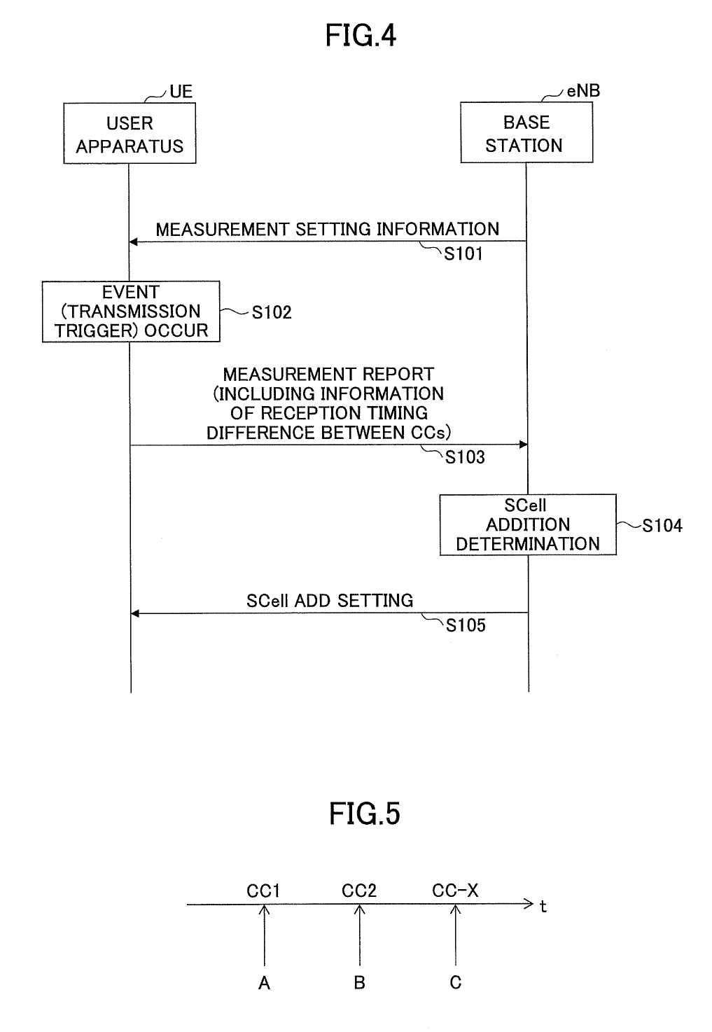

In one or more embodiments, the user apparatus UE includes information on an inter-CC reception timing difference in a measurement report transmitted to the base station eNB. FIG. 4 shows a sequence example in one or more embodiments. By the way, when adding an SCell, although a carrier (frequency) that is a candidate of a CC to be added is not a CC that forms CA before being added, it is called “CC” as a meaning of unused CC.

The base station eNB transmits measurement setting information to the user apparatus UE (step 101). The measurement setting information includes, for example, a frequency of a target for measurement, and a timing and a condition (event, threshold, and the like) for the user apparatus UE to transmit a measurement report. Also, the measurement setting information may include information indicating whether information on an inter-CC reception timing difference is included in the measurement report, and may include which information to include if it is to be included. The frequency (carrier) of the target which the user apparatus UE measures is not limited to a frequency specified by the measurement setting information.

In this example, it is assumed that the measurement setting information specifies to include information on the inter-CC reception timing difference.

The user apparatus UE that receives the measurement setting information performs measurement based on the setting information.

In this example, the user apparatus UE transmits a measurement report when an event that a reception quality (to be referred to as “reception quality” including reception level) of a neighbor cell (CC that is an addition candidate) becomes equal to or greater than a predetermined threshold occurs. In step 102, it is assumed that this event occurs.

In one or more embodiments, the user apparatus UE measures a reception timing difference between CCs in addition to a reception quality of each CC. For example, the user apparatus UE measures the reception timing difference between CCs based on timing at which a criterial signal (synchronization signal, reference signal and the like) that is transmitted by each CC is received. As an example, an inter-CC reception timing difference of a CC (CC that is an addition candidate) is defined as a difference with respect to a reception timing of a CC (CC of a connecting cell) that causes the largest reception timing difference. For example, as shown in FIG. 5, in a case where reception timings of CC1 and CC2 of connecting cells (Pcell, Scell) are indicated as A and B respectively, if a reception timing of a CC-X which is an addition candidate is C, the inter-CC reception timing difference of the CC-X (the largest inter-CC reception timing difference) becomes a time between A and C. Or, using a reception timing of a criterial signal of the PCC as a reference, a difference is measured between the reception timing of the PCC and reception timings of CCs of a connecting cell and a neighbor cell, so that, for a CC, a reception timing difference that becomes the largest with respect to other CCs may be obtained by calculation.

Being triggered by occurrence (step 102) of an event of measurement report transmission for a CC, the user apparatus UE transmits a measurement report to a base station eNB by including the reception quality of the CC and information on the inter-CC reception timing difference of the CC in the measurement report (step 103).

The information on the inter-CC reception timing difference may be, for example, a value itself of the largest reception timing difference with respect to the CC of the connecting cell, or, may be a result obtained by comparing the value with a predetermined threshold (equal to or greater than threshold, less than threshold, or the like).

The base station eNB that receives the measurement report determines whether to add an Scell of the CC based on the reception quality and the information on the inter-CC reception timing difference (step 104). For example, when the inter-CC reception timing difference is equal to or greater than a predetermined threshold, the base station eNB can determine not to add the SCell of the CC even though the reception quality is good.

In FIG. 4, as a result of determination in step 104, when it is determined to add an SCell, the base station eNB performs setting (configuration) of SCell addition to the user apparatus UE by an RRC signaling (step 105). That is, the base station eNB transmits an instruction to add an SCell to the user apparatus UE.

In the above-mentioned example, although “to include information on inter-CC reception timing difference” is instructed by an RRC signal (measurement setting information) to the user apparatus UE, this instruction may be performed by a signal (MAC signal, PHY signal and the like) other than the RRC signal. Also, when there is not the instruction “to include information on inter-CC reception timing difference”, the user apparatus UE does not include the information on the inter-CC reception timing difference in the measurement report. Alternatively, it is not included when there is an instruction “not to include information on inter-CC reception timing difference”, and it may be included when there is not the instruction.

In the above-mentioned example, an event that becomes a trigger for measurement report transmission corresponds to the event A4 defined in LTE. However, the event is not limited to that, and other events may be used.

For example, an event that becomes a trigger for measurement report transmission may be “when both of a condition of reception quality and a condition of inter-CC reception timing difference are satisfied”. For example, in a case where the condition of reception quality is “reception quality>threshold A” and a condition of inter-CC reception timing difference is “inter-CC reception timing difference<threshold B”, when the user apparatus UE detects “reception quality>threshold A” and “inter-CC reception timing difference<threshold B” for a neighbor cell (CC that is an addition candidate), the user apparatus UE performs measurement report transmission.

Which event (only quality, quality+reception timing difference, or the like) to use as a report trigger may be instructed to the user apparatus UE by an RRC signal (measurement setting information), or it may be instructed by a signal (MAC signal, PHY signal or the like) other than the RRC signal.

### Second Example

### A Case of Deleting an SCell

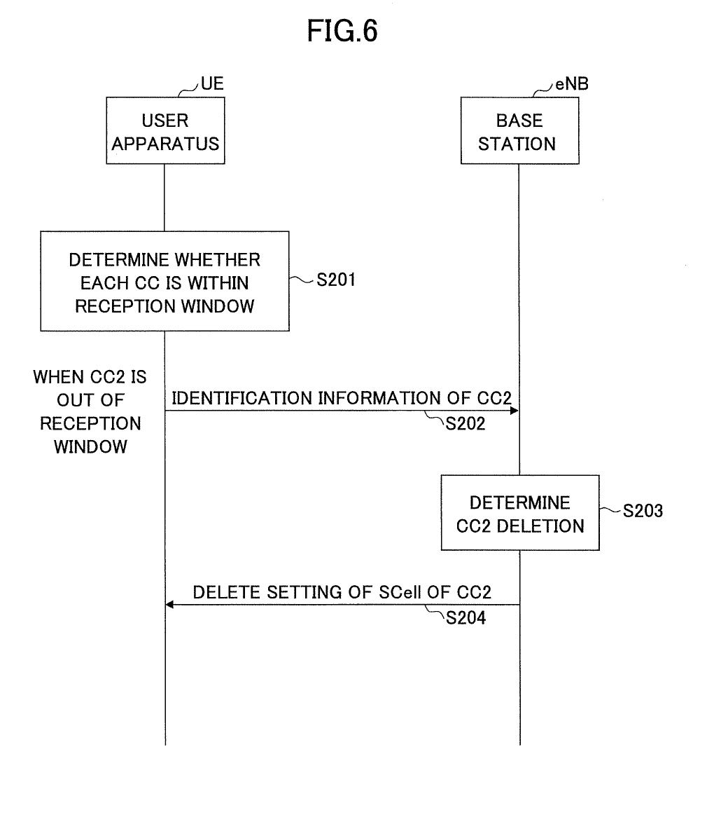

Next, a second example is described. In one or more embodiments, the user apparatus UE measures an inter-CC reception timing difference of a CC of each connecting cell (PCell, Scell), and reports, to the base station eNB, identification information (ServCellIndex, SCellIndex, and the like) of a CC that becomes out of a reception window. An operation of the second example is described according to the sequence diagram of FIG. 6.

As a precondition for the sequence shown in FIG. 6, it is assumed that the user apparatus UE is performing CA using a PCC (PCell) and one or a plurality of SCCs (SCells).

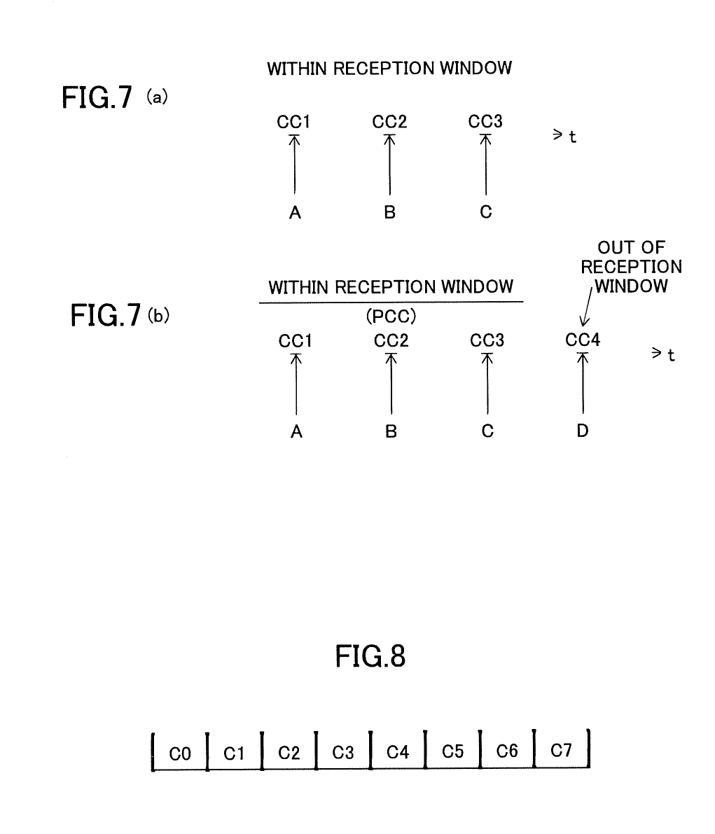

The user apparatus UE measures a reception timing of each CC to determine whether the reception timing of each CC is within a reception window (step 201). The reception window is, for example, a predetermined time width. That the reception timing of each CC is within the reception window is that, for example, the largest value of the inter-CC reception timing difference does not exceed the predetermined time width. As an example, as shown in FIG. 7 (a), in a case where reception timings of CC1, CC2 and CC3 of connecting cells (PCell, Scell) are shown as A, B and C respectively, if a time width between A and C falls within the predetermined time width of the reception window, these CCs are within the reception window.

Also, as shown in FIG. 7 (b), it is assumed that reception timings of CC1, CC2, CC3 and CC4 are shown as A, B, C and D respectively, and that a time width between A and D exceeds a predetermined time width. In this case, for example, by defining a CC (example: PCC) which becomes a reference, CCs can be determined to be out of reception window in an descending order in distance from the reception timing of the reference CC. In the case of FIG. 7(b), for example, when B is the PCC, D is determined to be out of reception window.

Other than the above-mentioned method, by defining a CC (example: PCC) which becomes a reference, it is possible to determine, as a CC out of reception window, a CC of a reception timing that is out of a predetermined time width that is centered on the reception timing of the reference CC. Also, within/out of reception window may be determined by methods other than these.

As a result of determination of step 201 of FIG. 6, the user apparatus UE reports, to the base station eNB, identification information (example: ServCellIndex, SCellIndex) of a CC determined to be out of reception window (step 202). This notification may be triggered by an event of the out-of-reception window, or may be one of periodical notifications.

In this example, the base station eNB determines to delete an SCell of the CC based on the CC becoming out of reception window (step 203), and performs SCell delete setting (configuration) to the user apparatus UE (step 204). That is, the base station eNB instructs the user apparatus to delete the SCell of the CC.

In the above-mentioned example, although a CC that becomes out of reception window is reported, information for reporting is not limited to this. For example, values of inter-CC reception timing difference for each CC (reception timing difference with respect to a CC as a reference, and the like) may be transmitted. In this case, the base station eNB determines whether CC is out of reception window for each CC based on the received values.

Although the information notification method from the user apparatus UE to the base station eNB in step 202 of FIG. 6 is not limited to a particular method, an RRC signal, a MAC signal, or a PHY signal may be used, for example.

When using the RRC signal, for example, a new IE (Information Element) is defined, to perform notification (reporting) by an RRC message. In this case, a measurement object for instructing a notification method and a threshold is defined, so that measurement setting information including the measurement object is transmitted from the base station eNB to the user apparatus UE.

As described before, although content of notification is not limited, for example, an inter-CC reception timing difference of each CC is included. Here, in the case where a value of an inter-CC reception timing difference and the like is reported, the value may have a certain amount of step, instead of transmitting the value itself which increases or decreases in a small unit, in which, for example, B is reported for A-B and C is reported for B-C. Also, when a CC is out of reception window, OCR (Out Of Range) which is information indicating that may be reported.

When using a MAC signal, for example, a new MAC CE (Control Element) is defined, so that reporting is performed by using the MAC CE. For example, a MAC CE as shown in FIG. 8 is prepared, bits are set for a combination of CCs by which reception timing falls within the reception window (or reception timing exceeds the reception window), so that the MAC CE in which the bits are set is transmitted to the base station eNB. In the example shown in FIG. 8, Ci indicates a bit field of ServCellIndex 1. For example, bit of C1 indicates that reception timing falls/does not fall within the reception window as to a CC whose ServCellIndex is 1.

In the case where a PHY signal is used, for example, a new reporting value (example: similar to the reporting value of the MAC signal) is introduced to the existing CSI reporting (CQI/RI/PMI/PTI), so that reporting is performed when performing CSI reporting (periodic or Aperiodic). In this case, a new reporting value on the inter-CC reception timing difference is reported with the existing CQI/RI/PMI/PTI. Also, new CSI reporting may be defined for reporting a reception timing difference.

Depending on movement of the user apparatus UE, difference of reception timing between CCs may change from moment to moment. If report of change is performed at each time when instantaneous change occurs, signaling overhead increases. Thus, Time to Trigger or hystereses may be applied.

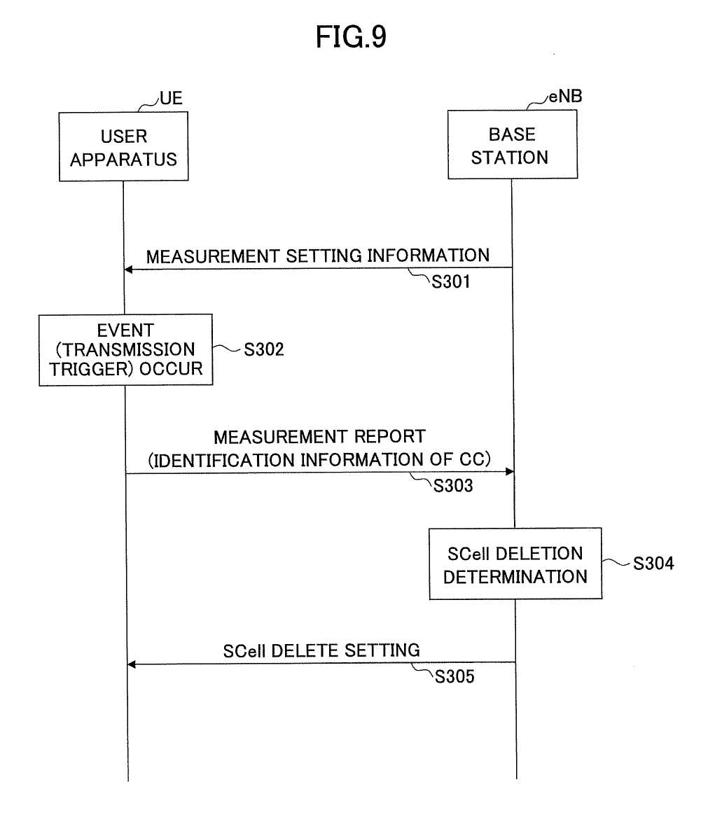

Another example in the second example is described according to a sequence of FIG. 9. In this example, for example, it is assumed that event A2 is set for each connecting CC by measurement setting information in step 301. In the event A2, a measurement report is triggered when the reception quality of the connecting cell becomes worse than a predetermined threshold. However, in one or more embodiments, “inter-CC reception timing difference exceeds a threshold” is added as a trigger condition of the event A2. By the way, “inter-CC reception timing difference exceeds a threshold” has the same meaning as “out of reception window occurs”. In this case, for example, determination can be made by OR between two conditions of the reception quality and the inter-CC reception timing difference (if any one of them is satisfied, reporting is performed).

Instead of adding the condition, the condition of reception quality may be replaced with “inter-CC reception timing difference exceeds a threshold” or “out of reception window occurs”.

The user apparatus UE monitors a reception timing of each connecting CC. For example, when out of reception window (or “inter-CC reception timing difference exceeds a threshold”) occurs for a CC as shown in FIG. 7 (b), the user apparatus UE determines that the condition of the event A2 is satisfied (a trigger occurs) (step 302). Then, the user apparatus UE transmits a measurement report including identification information of the CC to the base station eNB (step 303).

The base station eNB that receives the measurement report including the identification information of the CC of which reception timing is out of reception window determines to delete an SCell of the CC (step 304), and performs SCell deletion setting to the user apparatus UE (step 305).

When variations of the reception timing of the CC is large, it can be considered that, the reception timing soon becomes within the reception window after deletion so that the CC (SCell) is added, and then, it is soon deleted. Thus, after deletion, a prohibit period may be provided during which addition is not performed even though the condition of “within the reception window” is satisfied. The prohibit period may be a period during which the user apparatus UE does not transmit the measurement report to the base station eNB. Or, the prohibit period may be a period during which the base station eNB does not perform SCell addition even though it is determined that the adding condition is satisfied by receiving a measurement report on the CC. Also, as to the reporting, protection steps and the like may be considered such that ping-pong does not occur.

As a common feature for the first example and the second example, it can be considered that band combinations in which the inter-CC reception timing difference can be measured are limited depending on the implementation of the user apparatus UE.

Thus, the user apparatus UE may notify the base station eNB of band combination(s) in which the user apparatus UE can measure the reception timing difference as a capability. The base station eNB that receives the notification can set an Scell only in band combination(s) by which the user apparatus UE can measure the reception timing difference, for example. As a concrete capability notification method, the user apparatus UE may use a bit for reporting whether reception timing difference measurement is available for each CA band combination (and its subsets), or may report only CA band combination(s) (and the subsets) by which measurement is available.

(Apparatus Configuration, Operation Flow)

<User Apparatus UE>

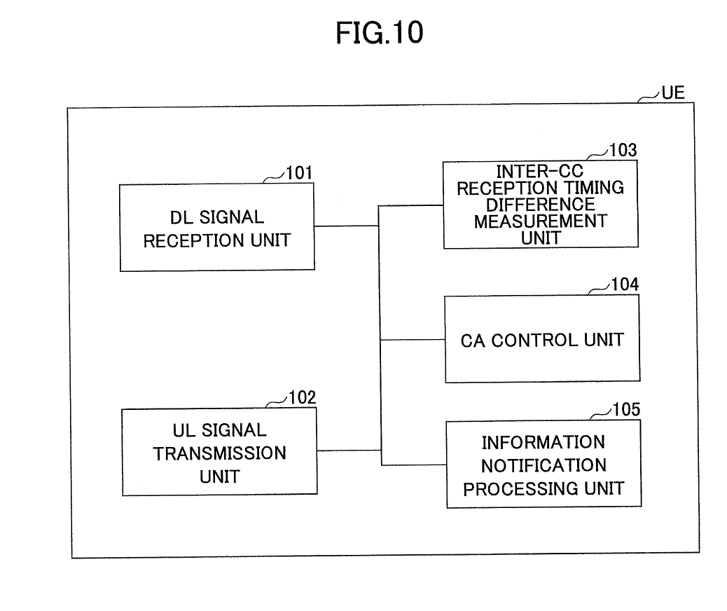

FIG. 10 shows a functional block diagram of the user apparatus UE in one or more embodiments. As shown in FIG. 10, the user apparatus UE includes a DL signal reception unit 101, an UL signal transmission unit 102, an inter-CC reception timing difference measurement unit 103, a CA control unit 104, an information notification processing unit 105. By the way, FIG. 10 shows only functional units especially related to the present invention, and also includes functions not shown in the figure at least for performing operation complying with LTE.

The DL signal reception unit 101 includes functions for receiving various downlink signals from the base station eNB to obtain information of an upper layer from the received physical layer signal. The UL signal transmission unit 102 includes functions for generating various signals of the physical layer from information of an upper layer that should be transmitted from the user apparatus UE to transmit the signals to the base station eNB.

The inter-CC reception timing difference measurement unit 103 measures an inter-CC reception timing difference of each CC of a connecting cell and a neighbor cell based on signals received by the DL signal reception unit 101. Also, the inter-CC reception timing difference measurement unit 103 also includes a function for detecting that the inter-CC reception timing difference exceeds a predetermined threshold (or falls within a predetermined threshold) by comparing the inter-CC reception timing difference with the predetermined threshold. Also, as described before, in the case where the reception quality is also considered as an event, the inter-CC reception timing difference measurement unit 103 may include a function for measuring the reception quality.

The CA control unit 104 performs control on CA in the user apparatus UE such as management of a PCell (PCC) and an SCell (SCC) that form CA, addition/deletion and activation/deactivation of an SCell based on an instruction from the base station eNB, or the like.

As described so far, the information notification processing unit 105 generates a message (MAC CE, RRC message, CSI information and the like) including a value of an inter-CC reception timing difference, identification information of a CC that exceeds a threshold, or the like, and performs processing for transmitting the message to the base station eNB by using the UL signal transmission unit 102.

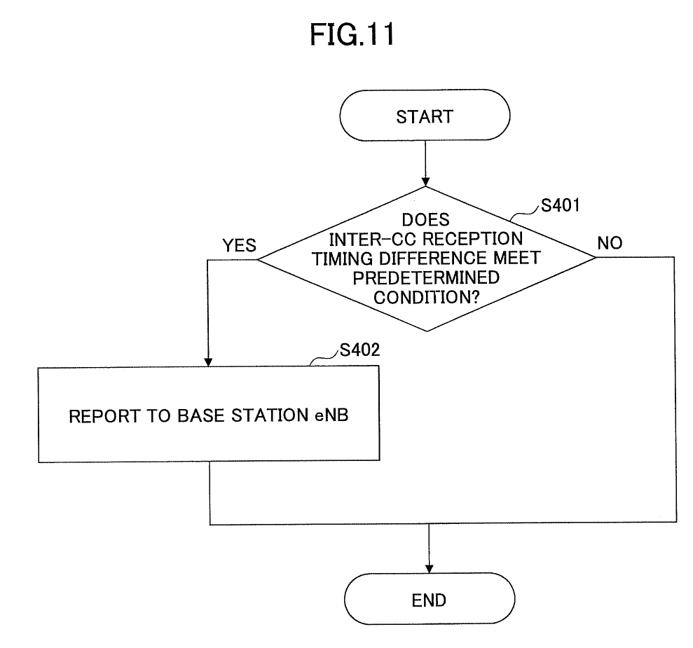

Next, with reference to a flowchart shown in FIG. 11, a basic operation example of the user apparatus UE is described. The operation example shown in FIG. 11 is an example in which reporting to the base station eNB is triggered by a condition based on the inter-CC reception timing difference.

The user apparatus UE is performing CA, and checks whether the condition based on the inter-CC reception timing diffidence is satisfied for each connecting cell (CC) (step 401). This condition is, for example, “there is a CC in which the inter-CC reception timing difference exceeds a predetermined threshold” or “there is a CC that becomes out of reception window”. When this condition is satisfied (Yes in step 401), the user apparatus UE reports, to the base station eNB, identification information of the CC that satisfies the condition (step 402), for example.

The functional configuration of the user apparatus UE is not limited to the above-mentioned one, and any configuration can be adopted that can realize the processing described in one or more embodiments. For example, the user apparatus UE may be configured to include a measurement unit configured to measure a reception timing difference between component carriers;

an information notification unit configured to notify the base station of information on the reception timing difference measured by the measurement unit; and

a control unit configured to perform addition or deletion of a secondary cell in the carrier aggregation based on an instruction from the base station that receives the information.

The information on the reception timing difference notified by the information notification unit is information, as to a component carrier, indicating whether a reception timing difference between the component carrier and a component carrier, in other component carriers, by which the reception timing difference becomes the largest is less than a predetermined threshold. By transmitting such information to the base station, the base station can perform, as to a CC that is an addition candidate, addition of an SCell by considering determination whether the reception timing difference is less than a predetermined threshold, so that, for example, it becomes possible to avoid adding a CC whose reception quality is good but reception timing is shifted.

For example, based on a trigger that a reception quality of the component carrier becomes equal to or greater than a predetermined threshold, the information notification unit notifies the base station of the information on the reception timing difference. Accordingly, for example, the information on the reception timing difference can be reported to the base station using event A4 as a trigger. In the base station side, it becomes possible to add a proper CC as an SCell by considering the reception timing difference together with the reception quality.

The information on the reception timing difference notified by the information notification unit is, for example, identification information of a component carrier whose reception timing is out of a reception window which is a predetermined time width. By transmitting such identification information, the base station can properly ascertain a component carrier that is out of reception window, so that, for example, it is possible to delete an SCell, whose reception timing is largely shifted, that cannot be used.

Based on a trigger that the reception timing of the component carrier becomes out of the reception window, the information notification unit can notify the base station of the information on the reception timing difference. Accordingly, the base station can quickly ascertain a CC in which shift of reception timing occurs.

Also, the information notification unit can notify the base station of the information on the reception timing difference by using an RRC message, a MAC control element, or a CSI reporting.

<Base Station eNB>

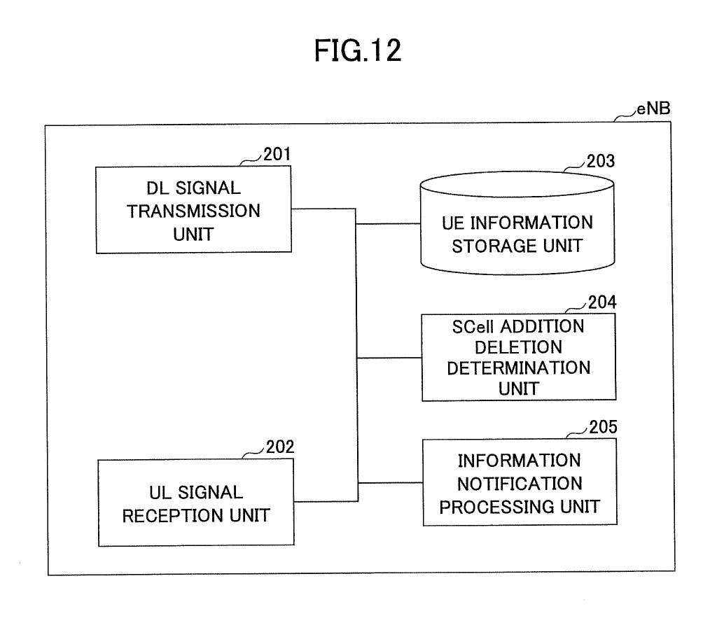

FIG. 12 shows a functional block diagram of the base station eNB in one or more embodiments. As shown in FIG. 12, the base station eNB includes a DL signal transmission unit 201, an UL signal reception unit 202, a UE information storage unit 203, an SCell addition deletion determination unit 204 and an information notification processing unit 205. By the way, FIG. 12 shows only functional units especially related to one or more embodiments of the present invention, and also includes functions not shown in the figure at least for performing operation complying with LTE.

The DL signal transmission unit 201 includes functions for generating various signals of the physical layer from information of an upper layer that should be transmitted from the base station eNB to transmit the signals to the user apparatus UE. The UL signal reception unit 202 includes functions for receiving various uplink signals from the user apparatus UE to obtain information of an upper layer from the received physical layer signal.

The UE information storage unit 203 stores information on the user apparatus UE such as capability information for each user apparatus UE, current CA states (connected CCs and the like) and the like, in which this information is always updated and this information is the newest information. Based on notification information received from the user apparatus UE, the SCell addition deletion determination unit 204 determines deletion of an existing SCell that can be ascertained from UE information stored in the UE information storage unit 203, and addition of a new SCell to a current CA configuration, or the like. For example, when the SCell addition deletion determination unit 204 receives a report, for a CC that is not used as an SCell, indicating that reception quality is good, and the inter-CC reception timing difference is small, the SCell addition deletion determination unit 204 determines to add an Scell of the CC. Also, for example, when the SCell addition deletion determination unit 204 receives a report indicating that, for a CC of a connecting cell, the inter-CC reception timing difference is greater than a threshold, the SCell addition deletion determination unit 204 determines to delete an SCell of the CC.

The information notification processing unit 205 includes functions for generating a message for reporting, to the user apparatus UE, content of measurement, threshold, an event that is a report trigger and the like, and transmitting the message to the user apparatus UE by the DL signal transmission unit 201. Also, when the SCell addition deletion determination unit 204 determines addition/deletion of an SCell, the information notification processing unit 205 generates a message for performing setting of adding/deleting of an SCell to the user apparatus UE, and transmits the message to the user apparatus UE by the DL signal transmission unit 201.

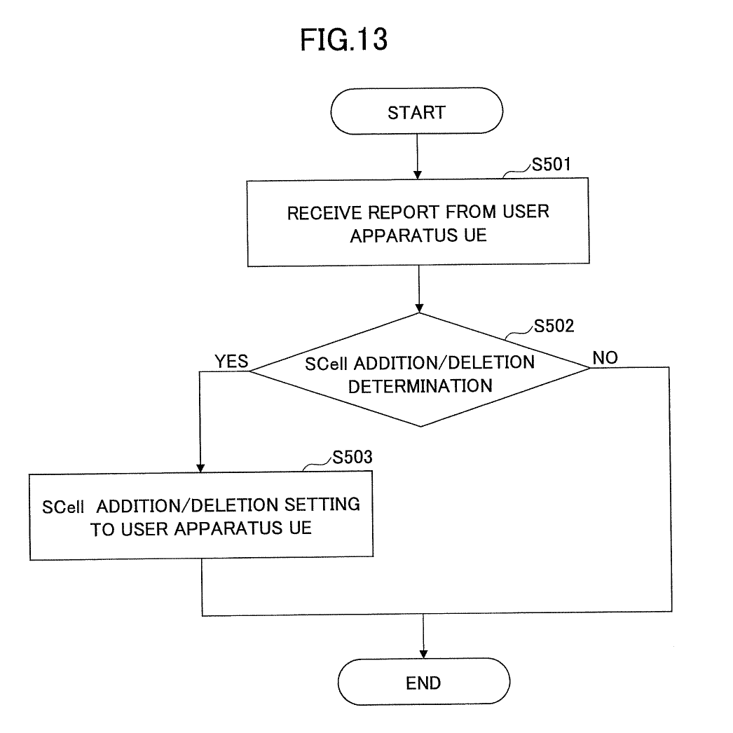

With reference to a flowchart of FIG. 13, a basic operation example of the base station eNB is described. In the example of FIG. 13, first, the base station eNB receives a report from the user apparatus UE (step 501). This report includes, for example, information indicating that an inter-CC reception timing difference of a CC exceeds a predetermined threshold.

The user apparatus UE performs SCell addition/deletion determination based on the report received in step 501 (step 502). For example, as mentioned above, when receiving information as the report indicating that an inter-CC reception timing difference of a CC exceeds a predetermined threshold, the base station eNB determines to delete the SCell of the CC. The base station eNB performs SCell addition/deletion setting to the user apparatus UE based on the determination result in step 502 (step 503).

The functional configuration of the base station eNB is not limited to the above-mentioned one, and any configuration can be adopted that can realize the processing described in one or more embodiments. For example, the base station eNB may be configured to include

a reception unit configured to receive, from a user apparatus, information on a reception timing difference between component carriers for a component carrier;

a determination unit configured to determine whether to add or delete a secondary cell corresponding to the component carrier based on information on the reception timing difference received by the reception unit; and

an information notification unit configured to instruct the user apparatus to add or delete the secondary cell based on a determination result by the determination unit.

The user apparatus described in one or more embodiments may include a CPU and a memory and may be realized by executing a program by the CPU (processor), or may be realized by hardware such as hardware circuits including logics of processing described in one or more embodiments, or may be configured by coexistence of a program and hardware.

The base station described in one or more embodiments may include a CPU and a memory and may be realized by executing a program by the CPU (processor), or may be realized by hardware such as hardware circuits including logics of processing described in one or more embodiments, or may be configured by coexistence of a program and hardware.

In the above, embodiments of the present invention have been explained. However, the disclosed invention is not limited to the embodiments. Those skilled in the art will conceive of various modified examples, corrected examples, alternative examples, substituted examples, and the like. While specific numerical value examples are used to facilitate understanding of the present invention, such numerical values are merely examples, and any appropriate value may be used unless specified otherwise. Classification into each item in the description is not essential in the present invention, and features described in two or more items may be combined and used as necessary. Subject matter described in an item may be applied to subject matter described in another item (provided that they do not contradict).

It is not always true that the boundaries of the functional units or the processing units in the functional block diagram correspond to boundaries of physical components. The operations by the plural functional units may be physically performed by a single component. Alternatively, the operations by the single functional unit may be physically performed by plural components.

For convenience of explanation, the user apparatus and the base station have been explained by using functional block diagrams. However, such an apparatus may be implemented in hardware, software, or a combination thereof. The software that operates by a processor provided in the user apparatus according to the embodiments of the present invention, and the software that operates by a processor provided in the base station according to the embodiments of the present invention may be stored in any proper storage medium such as a Random Access Memory (RAM), a flash memory, a Read Only Memory (ROM), an EPROM, an EEPROM, a register, a hard disk (HDD), a removable disk, a CD-ROM, a database, a server and the like.

The present invention is not limited to the above-mentioned embodiments and is intended to include substitutions and so on without departing from the spirit of the present invention.

The present international patent application claims priority based on Japanese patent application No. 2014-024832, filed in the JPO on Feb. 12, 2014, and the entire contents of the Japanese patent application No. 2014-024832 are incorporated herein by reference.

### DESCRIPTION OF REFERENCE SIGNS

UE user apparatus
eNB base station
101 DL signal reception unit
102 UL signal transmission unit
103 inter-CC reception timing difference measurement unit
104 CA control unit
105 information notification processing unit
201 DL signal transmission unit
202 UL signal reception unit
203 UE information storage unit
204 SCell addition deletion determination unit
205 information notification processing unit

1. A user apparatus in a mobile communication system supporting carrier aggregation, comprising:
a measurement unit configured to measure a reception timing difference between component carriers;
an information notification unit configured to notify the base station of information on the reception timing difference measured by the measurement unit; and
a control unit configured to perform addition or deletion of a secondary cell in the carrier aggregation based on an instruction from the base station that receives the information.

2. The user apparatus as claimed in claim 1, wherein, the information on the reception timing difference notified by the information notification unit is information, as to a component carrier, indicating whether a reception timing difference between the component carrier and a component carrier, in other component carriers, by which the reception timing difference becomes the largest is less than a predetermined threshold.

3. The user apparatus as claimed in claim 2, wherein, based on a trigger that a reception quality of the component carrier becomes equal to or greater than a predetermined threshold, the information notification unit notifies the base station of the information on the reception timing difference.

4. The user apparatus as claimed in claim 1, wherein, the information on the reception timing difference notified by the information notification unit is identification information of a component carrier whose reception timing is out of a reception window which is a predetermined time width.

5. The user apparatus as claimed in claim 4, wherein, based on a trigger that the reception timing of the component carrier becomes out of the reception window, the information notification unit notifies the base station of the information on the reception timing difference.

6. The user apparatus as claimed in claim 1, wherein the information notification unit notifies the base station of the information on the reception timing difference by using an RRC message, a MAC control element, or a CSI reporting.

7. A base station in a mobile communication system supporting carrier aggregation, comprising:
a reception unit configured to receive, from a user apparatus, information on a reception timing difference between component carriers for a component carrier;
a determination unit configured to determine whether to add or delete a secondary cell corresponding to the component carrier based on information on the reception timing difference received by the reception unit; and
an information notification unit configured to instruct the user apparatus to add or delete the secondary cell based on a determination result by the determination unit.

8. A carrier aggregation control method executed by a user apparatus in a mobile communication system supporting carrier aggregation, comprising:
a measurement step of measuring a reception timing difference between component carriers;
an information notification step of notifying the base station of information on the reception timing difference measured by the measurement step; and
a control step of performing addition or deletion of a secondary cell in the carrier aggregation based on an instruction from the base station that receives the information.

9. A carrier aggregation control method executed by a base station in a mobile communication system supporting carrier aggregation, comprising:
a reception step of receiving, from a user apparatus, information on a reception timing difference between component carriers for a component carrier;
a determination step of determining whether to add or delete a secondary cell corresponding to the component carrier based on information on the reception timing difference received by the reception step; and
an information notification step of instructing the user apparatus to add or delete the secondary cell based on a determination result by the determination step.

10. The user apparatus as claimed in claim 2, wherein the information notification unit notifies the base station of the information on the reception timing difference by using an RRC message, a MAC control element, or a CSI reporting.

11. The user apparatus as claimed in claim 3, wherein the information notification unit notifies the base station of the information on the reception timing difference by using an RRC message, a MAC control element, or a CSI reporting.

12. The user apparatus as claimed in claim 4, wherein the information notification unit notifies the base station of the information on the reception timing difference by using an RRC message, a MAC control element, or a CSI reporting.

13. The user apparatus as claimed in claim 5, wherein the information notification unit notifies the base station of the information on the reception timing difference by using an RRC message, a MAC control element, or a CSI reporting.
